(19) United States
(12) Patent Application Publication
(10) Pub. No.: US 2024/0020167 A1
(43) Pub. Date: Jan. 18, 2024

(54) KEY-VALUE STORAGE ENGINE FOR RANGE SCAN SORTED QUERIES

(71) Applicants: Lemon Inc., Grand Cayman (KY); Beijing Volcano Engine Technology Co., Ltd., Beijing (CN)

(72) Inventors: Jiaxin Ou, Beijing (CN); Hao Wang, Los Angeles, CA (US); Ming Zhao, Beijing (CN); Yi Wang, Beijing (CN); Zhengyu Yang, Los Angeles, CA (US)

(21) Appl. No.: 18/475,763

(22) Filed: Sep. 27, 2023

(51) Int. Cl. G06F 9/50; G06F 11/14; G06F 16/18

(52) U.S. Cl. CPC G06F 9/5038; G06F 9/505; G06F 11/1435; G06F 16/1847

(57) ABSTRACT

By splitting data within a large LSM tree structure into smaller tree structures to reduce a number of layers in such a structure, write amplification factor (WAF) is efficiently reduced. By further classifying and labeling each I/O based on type, a lower-level filesystem is able to prioritize scheduling between different types of I/O to thereby facilitate stable latency for individual conjunction within the filesystem layer and for individual I/O operations.

### TECHNICAL FIELD

The embodiments described herein pertain generally to promoting efficient storage and retrieval of data in a solid-state device (SSD).

### BACKGROUND

A key-value (KV) storage engine renders SSDs more efficient than existing block-and-object storage systems. However, write-amplification factor (WAF) and tail latency negatively affect performance and system efficiency of KV storage engines. WAF is calculated as a measurement of how much data is written to an SSD compared to an amount of data that is requested by the host system. That is, WAF may be expressed as a ratio of writes committed to an SSD as opposed to writes coming from the host system.

### SUMMARY

In one example embodiment, a method to optimize non-volatile storage includes splitting data in a first log-structured merge (LSM) tree structure into partitioned shards to reduce a number of layers for the data represented in the first LSM tree structure. Each partitioned shard represents an independent LSM tree structure, thus providing scalability and flexibility for the data represented in the first LSM tree structure. The method further includes splitting a respective one of the partitioned shards into at least a parent shard and a child shard when a volume of data therein reaches a threshold level or merging a respective one of the partitioned shards into an adjacent one of the partitioned shards when a volume of data of the respective one of the partitioned shards decreases to a volume less than the threshold level.

In accordance with at least one other example embodiment, a non-volatile storage has stored thereon executable components that include a sharding manager configured to split data in a first log-structured merge (LSM) tree structure into partitioned shards to reduce a number of layers for the data represented in the first LSM tree structure. Each partitioned shard represents an independent LSM tree structure, thus providing scalability and flexibility for the data represented in the first LSM tree structure. The sharding manager is also configured to split a respective one of the partitioned shards into at least a parent shard and a child shard when a volume of data therein reaches a threshold level or to merge a respective one of the partitioned shards into an adjacent one of the partitioned shards when a volume of data of the respective one of the partitioned shards decreases to a volume less than the threshold level.

### BRIEF DESCRIPTION OF THE DRAWINGS

In the detailed description that follows, embodiments of a non-volatile storage and operations for facilitating a weighted memory scan therefore are described as illustrations only since various changes and modifications will become apparent to those skilled in the art from the following detailed description. The use of the same reference numbers in different figures indicates similar or identical items.

FIG. 1 shows an example architecture of a key-value store and filesystem, in accordance with at least some embodiments described and recited herein.

FIG. 2A shows a non-limiting example of a sorted engine, and FIG. 2B shows a more detailed view of timestamp management implemented by the sorted engine, arranged in accordance with at least some embodiments described and recited herein;

FIG. 3 shows a non-limiting example of database engine management, with FIGS. 3A-3C showing stages of data splitting, all in accordance with at least some embodiments described and recited herein, and FIG. 3D is an illustration of a consistent cross-shard range scan, in accordance with the non-limiting example embodiments of data splitting described and recited herein;

FIG. 4 shows a non-limiting example of database engine management, with FIGS. 4A-4C showing stages of data merging, all in accordance with at least some embodiments described and recited herein;

FIG. 5A shows a non-limiting example storage processing flow, in accordance with at least some embodiments described and recited herein; FIG. 5B shows an example implementation of I/O job scheduling, and FIG. 5C shows a more detailed view thereof; and FIG. 5D shows a more detailed view of I/O classification; and

FIG. 6 shows an illustrative computing embodiment, in which any of the processes and sub-processes of training a unified transformer-based VPR training framework may be implemented as executable instructions stored on a non-volatile computer-readable medium.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of a successive drawing may reference features from any previous drawing to provide clearer context and a substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described and recited herein, as well as illustrated in the drawings, may be arranged, substituted, combined, separated, and designed in a wide variety of different configurations, all of which are explicitly contemplated herein.

Additionally, portions of the present disclosure may be described herein in terms of functional block components and various processing steps. It should be appreciated that such functional blocks may be realized by any number of firmware, software, and/or hardware components configured to perform the specified functions.

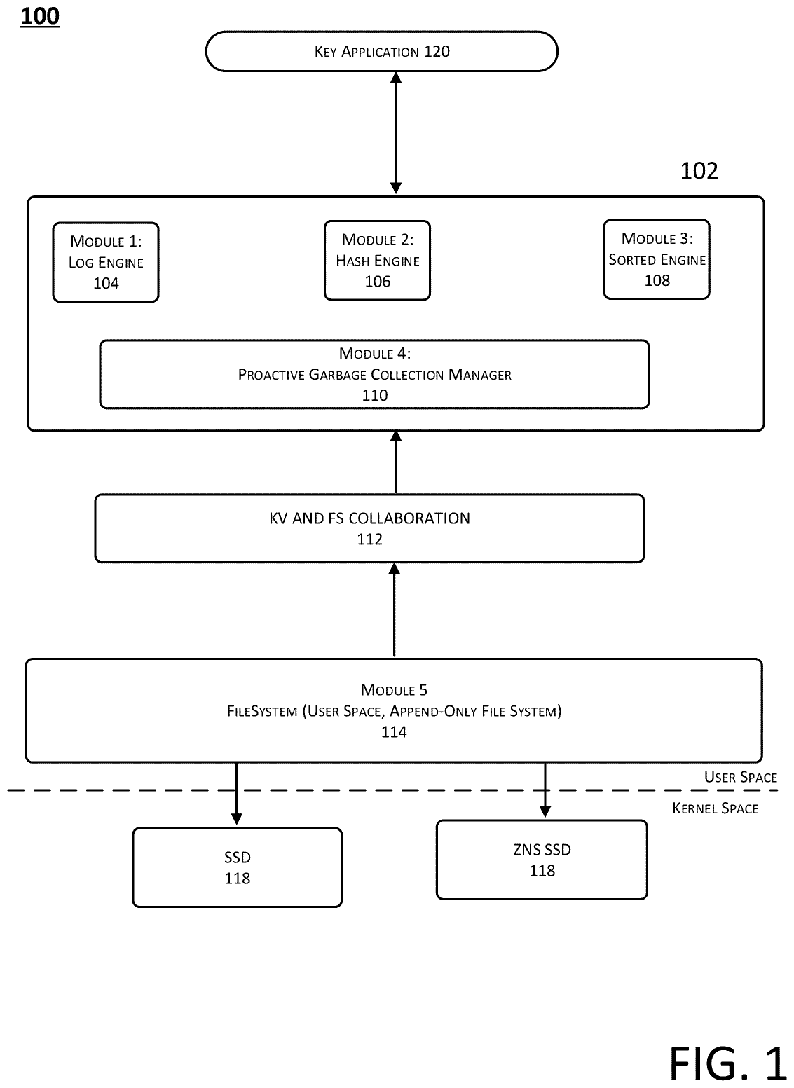

FIG. 1 shows an example architecture of a key-value store and filesystem, in accordance with at least some embodiments described and recited herein.

As referenced herein, a “key-value engine” may refer to a network, algorithm, programs, software, hardware, firmware, or any combination thereof configured or otherwise provide a key-value store for meeting a persistence requirement of cloud service providers. The key-value engine may be based on log-structured merge (LSM) tree architectures in which the key-values are separated to reduce write-amplification and/or resource contention. The key-value engine may be configured to store data in in-memory key-value stores (KVSes). In some embodiments, the LSM-tree may be used to achieve high-speed writes by buffering all updates in an in-memory structure, e.g., a MemTable. When the MemTable is full, the data may be flushed to persistent storage in a sorted-string table (SST), in which the SSTs are immutable. In some embodiments, in order to optimize read operations and reduce space usage, a compaction may be used to merge several SSTs into one to reduce overlaps, e.g., due to overlapping key ranges in multiple SSTs.

Key-value store and filesystem 100 includes key-value engine 102. Key-value engine 102 may include one or more of a log engine 104, a hash engine 106, a sorting engine 108, and a garbage collection manager module 110. Key-value store and filesystem 100 may further include a collaboration layer 112 and filesystem 114. Key-value store and filesystem 100 may interact with a kernel space 116, kernel space 116 including one or more disks 118. The key-value store and filesystem 100 may also interact with applications 120.

Key-value store and filesystem 100 may be used for data storage in cloud applications, for example to provide data persistence required by cloud services. Key-value engine 102 may be configured to provide a key-value store, for example as part of a storage backend for cloud services. Non-limiting examples of cloud services using key-value engines 102 include internet-based shopping, social media, metadata management, and the like. Filesystem 114 may be a dedicated user-level append-only filesystem configured to provide storage specialized to facilitate operation of key-value engine 102.

Log engine 104 may be configured to allow concurrent writing of multiple log files, thereby reducing the number of compaction and garbage collection operations. The logs written by log engine 104 may be configured such that strong sorting is not required for handling of said logs. Log engine 104 may be configured to improve throughput performance issue in log writes and increase recovery speed by reducing the sync write overhead of logs from multiple input/output (I/O) operations to a single I/O operation, aggregating writes using a lock-free queue to control latency and improve throughput, and/or providing asynchronous interfaces to enhance the thread model. The key-value engine 102 and filesystem 114 may be integrated and configured to collaborate with each other, the log engine 104 may be used to store a write-ahead log (WAL) having a predefined structure having a defined actual file size. The defined file size for the WAL may in turn result in requiring fewer I/O operations, thereby enhancing performance while mitigating potential tradeoffs regarding data consistency.

Hash engine 106 may be configured to handle point queries within the key-value engine 102. In particular, hash engine 106 is configured to reduce tail latency in point queries. The hash engine 106 includes separation of data and index components, and maintenance of the index in a cache memory, for example by compression of the index and/or caching of partial data. The partial data may be selected using, for example, a least recently used strategy.

Sorting engine 108 is configured to execute range scan operations while reducing the write-amplification factor and/or read/write latency associated with such operations. Sorting engine 108 is configured to use a partitioned log-structured merge (LSM) tree. The classification of I/O flows and scheduling of tasks may further be carried out by sorting engine 108.

Garbage collection manger module 110 is configured to execute garbage collection and/or compaction operations in key-value store and filesystem 100. The garbage collection manager module 110 may be configured to reduce unnecessary data movement during garbage collection and/or compaction operations in the key-value store and filesystem 100. The garbage collection manager module 110 may conduct garbage collection and/or compaction operations based on awareness regarding application-side data deletion such as expiration of pages. Garbage collection and compaction carried out by garbage collection manager module 110 may be configured to arrange the data to support other modules such as sorting engine 108. The garbage collection manager module 110 may be configured to coordinate preservation of data during the garbage collection and/or compaction operations.

Collaboration layer 112 is configured to facilitate collaboration between key-value (KV) engine 102 and filesystem (FS) 114. Collaboration layer 112 may further facilitate efficient compaction and/or garbage collection operations in key-value engine 102 based on the collaboration between the key-value engine 102 and filesystem 114. The collaboration may reduce write amplification issues arising from compaction and/or garbage collection operations. In an embodiment, the collaboration layer 112 may expose zone usage information from key-value engine 102 to the filesystem 114.

Filesystem 114 may be configured to split data from logs and use log-structured append-only writing as the write model. In an embodiment, the filesystem may further provide pre-allocated data space where sync writes only occur for the persistence of data, and in an embodiment, do not need to make metadata persistent. In an embodiment, the data persistence for different files and global log persistence may be executed separately. These aspects of the filesystem may allow the filesystem to avoid some metadata persistence operations, such as those caused by single data write persistence operations.

The filesystem 114 may be configured to support general files and instant files. Both general and instant files may be written sequentially, and both may be read either sequentially or randomly. General files may be optimized for consistently low latency in either sequential or random reads. General files may be used for writing data in batches that do not require flushing the data to disk after each write, such as SST files. The storage space is allocated in large units, with a non-limiting example of unit size being 1 MB each. The large allocation unit may reduce metadata size for general files, such that metadata of all general files may be kept in memory during normal filesystem operation. By keeping the metadata in memory, no read operation to general files would require further I/O for metadata access, regardless of the read offset. This may reduce read tail latency for general files. Instant files may be optimized for fast, incremental synchronous writes while having good sequential and random read performance near the tail. Instant files may be used for writing data that requires frequent flushing to disk for instant durability, such as write-ahead log files of the key-value system. The data and metadata of each individual write may be bundled together for instant files. The bundled data and metadata may be written to a journal file shared by all instant files. The bundling of data and writing to the journal file may improve the speed of incremental write and sync operations. This approach is structured to support sequential reads, but may have tradeoffs regarding random reads. Since instant files are expected to be mostly read sequentially, with random reads mostly concentrated near the tail most recently written data of each instant file that is actively being written may be cached to improve read performance.

The filesystem 114 may include a user-space I/O scheduler to assign I/O priority to different I/O types. The I/O scheduler will mark foreground I/O as high priority while background I/O will be marked as low priority. In addition, the key-value engine 102 may include a scheduler to schedule its background tasks in order to ensure that each I/O issued by the upper layer applications has a consistent I/O amplification. Through this co-design of I/O scheduling in both key-value engine 102 and filesystem 114, the tail latency may be kept stable and low as both the I/O amplification and I/O latency are consistent. Moreover, reading general files from the filesystem requires no I/O for metadata, and use of large spaces for the general files may ensure that most read operations require a single I/O.

Kernel space 116 may contain disks 118. Disks 118 may include one or more storage media, such as solid state drives (SSDs). In an embodiment, at least some of disks 118 are zoned storage (ZNS) SSDs.

Applications 120 may be any suitable applications utilizing the key-value store and filesystem 100, for example, online shopping, social media, metadata management applications, or the like. The applications 120 may interface with key-value store and filesystem 100 through any suitable application programming interface (API). In an embodiment, the API may be specific for the particular type of file, for example having the nature of the files as general files or instant filed be determined by the API through which the file has been received.

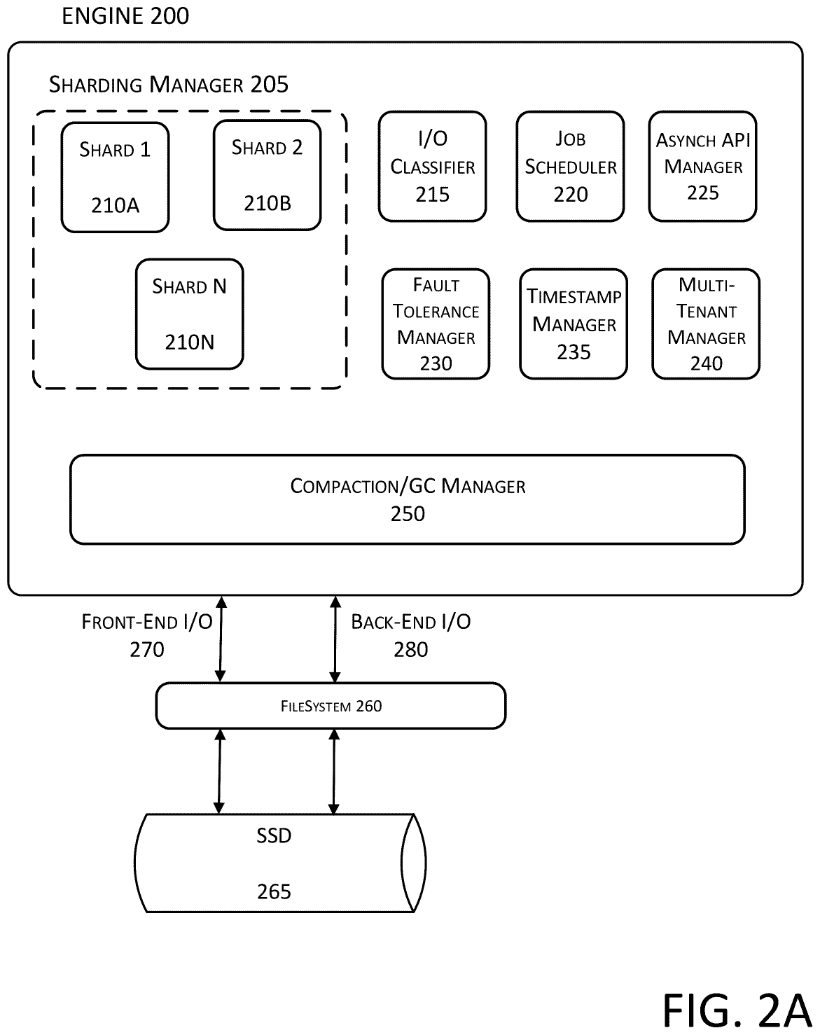

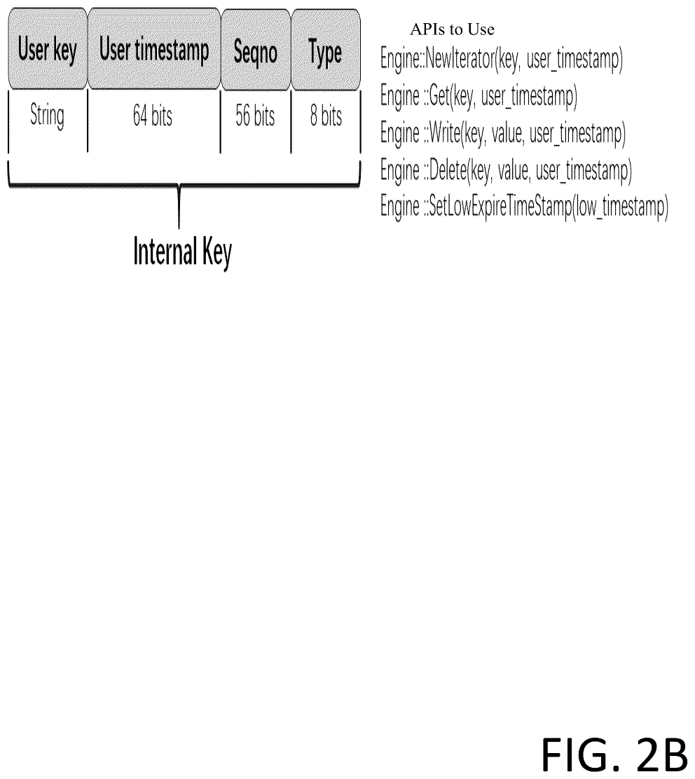

FIG. 2 shows a non-limiting example of a sorted engine, arranged in accordance with at least some embodiments described and recited herein.

Sorted engine 200 may be implemented, arranged in accordance with at least some embodiments described and recited herein. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof.

In accordance with the non-limiting example embodiments described and recited herein, sorted engine 200 may include various modules that reduce WAF, reduce tail latency, support asynchronous input/output (I/O) execution/compaction threads to prevent one I/O blocking another, support fault recovery, support multiversion concurrency control (MVCC), etc.

Initialization of a database (DB) class provides functionalities for managing and interacting with an underlying storage engine. The initialized DB class includes methods that function to, e.g., initialize the database with specified options, including, but not limited to creating an engine with given options, engine name, and engine type, returning an engine handle, dropping sorted engine 200 along with its associated data, retrieving an engine handle for a specified engine name, etc.

Initialization of an engine reader class provides an interface to read data from sorted engine 200; retrieving data asynchronously and synchronously, respectively from sorted engine 200. Initializing of an iterator class provides an iterator to traverse data across divided data structures, as will be discussed further below; initialization of one or more retrieval classes provides methods to, e.g., return a handle for a portion of a divided data structure, retrieve properties of specific portion of a divided data structure, retrieve a type of sorted engine 200.

Initialization of a reader class provides an interface to read data from a specific portion of a divided data structure and, e.g., retrieving data asynchronously and synchronously, respectively, within the range of the portion of a divided data structure.

Initialization of a write class provides functionalities for writing data to sorted engine 200 and, e.g., writing to store key-value pair synchronously, merging an entry for a given key with a new value, deleting a key-value pair, removing a range of key-values, etc.

Initialization of an assignment class provides functionalities for assigning key ranges to key-value sorted engine 200, rejecting key access that does not belong to any assigned range, etc. Initialization of a recovery class provides functionalities for checking consistency of ranges between an application and a key-value layer, splitting a portion of a divided data structure by a split key, merging adjacent portions of a divided data structure, etc.

Initialization of a garbage collection (GC) filter provides functionalities for reclaiming obsolete key-value pairs in a background GC process and, in accordance with at least some non-limiting example embodiments, provide virtual filtering that may be overridden to define filtering logic.

Hereafter, the aforementioned portion or portions of a divided data structure may be alternatively referred to as a shard or shards, which may refer to partitioned data in a database or engine structure.

Accordingly, initialization of a shard writer class provides functionality of writing data to a shard, merging entries, deleting entries, and removing a range of entries, etc.

As depicted, sorted engine 200 is implemented as a component or module for implementing database management for a non-volatile storage device, e.g., SSD 265. Device 20 includes, at least sharding manager 205, I/O classifier 215, job scheduler 220, asynch API manager 225, fault tolerance manager 230, timestamp manager 235, multi-tenant manager 240, and compaction/garbage collection (GC) manager 250. Further depicted is filesystem 260.

Filesystem 260 refers to a data structure that controls the storage and retrieval of data to and from a storage medium, e.g., SSD 265.

Sharding manager 205 refers to a component or module that is programmed, designed, or otherwise configured to split, automatically or manually, data in a large LSM tree structure into smaller LSM tree structures, i.e., shard 1 210A, shard 2 210B . . . Shard N 210N; thereby reducing the total number of layers in the LSM tree and minimizing write amplification. That is, when data within an LSM tree structure reaches a certain threshold, the data structure may be manually or automatically split into two sub-shards. Conversely, when the data within a data structure decreases due to deletions, and the volume thereof falls below a specific threshold, the data structure may be manually or automatically merged with one or more adjacent shards to form a single shard. Thus, sharding manager 205 is further programmed, designed, or otherwise configured to merge two or more shards for which respective data volume is beneath a predetermined threshold value.

Sharding manager 205 ensures the atomicity of a split operation that a split either succeeds entirely or fails completely, without splitting any data in a respective shard while failing with other data. Any failed operations must be properly rolled back to maintain data integrity. Further, sharding manager 205 operates in a manner to minimize impact on frontend I/O operations.

I/O classifier 215 refers to a component or module that is programmed, designed, or otherwise configured to classify and label each I/O based on its type, facilitating a lower-level filesystem to e scheduling between different types of I/O to- and from-storage, thus ensuring stable latency for individual I/O operations. That is, to ensure timely thread scheduling for high-priority tasks, multiple distinct background thread pools are maintained, each designed for executing different types of background tasks that include, but are not limited to, in order of descending priority, flush operations, L0->L1 compaction tasks, and L1->LN compaction tasks. L0->L1 compaction directly preempt L1->LN compaction.

Using separate thread pools for different tasks does not fully solve a problem of I/O between different tasks fairly competing for limited backend I/O bandwidth. The I/O bandwidth of high-priority tasks may be preempted by low-priority tasks, leading to untimely processing and impacting foreground latency stability. Thus, to prevent blocking their I/O execution, bandwidth limits for flush and L0->L1 compaction are set as W bytes/sec each. Thus, bandwidth thresholds for the three tasks are dynamically adjusted based on their priorities, gradually increasing or decreasing the bandwidth upper limits for different tasks based on their priority.

Job scheduler 220 refers to a component or module that is programmed, designed, or otherwise configured to cooperate with FS layer 260 to ensure stable latency for individual I/O operations to- and from-storage, e.g., SSD 265. Job scheduler 220 provides stable read amplification in the KV layer and prevents adverse conditions, e.g., WriteStall and WriteStop, to enhance or even optimize data retrieval and reduce tail latency.

Asynch API manager 225 refers to a component or module that is programmed, designed, or otherwise configured to manage I/O operations to- and from-storage, e.g., SSD 265, so that I/O waiting does not block upper layer threads from executing other tasks. That is, Async API manager 225 collaborates with underlying filesystem 260 to alleviate blocking of I/O operations, thereby improving parallelism, latency, and response time, by collaborating to select an executor for executing asynchronous tasks and asynchronous task callbacks.

It is noted that an executor is a component that manages execution of tasks in a concurrent manner, providing control over factors such as thread pools, thread priorities, and task scheduling. It is crucial to establish which entity or component will have the authority to decide and configure the Executor that handles the main body of asynchronous tasks. Further, a call back is a function or executable component or module that is executed upon the completion of an asynchronous task. An assigned executor assigned to execute a call back facilitates an outcome of the task and subsequent actions. Defining who will be responsible for setting up and configuring this call back executor is a priority for ensuring proper execution and handling of call backs associated with asynchronous tasks.

Fault tolerance manager 230 refers to a component or module that is programmed, designed, or otherwise configured to provide sector-level fault tolerance capabilities so that single sector corruption within a file does not affect data consistency and visibility.

That is, to prevent individual sector damage on disks from rendering specific files or data unreadable, which results in the entire DB data for the upper-layer distributed system being reconstructed, either data redundancy blocks for critical file data are generated to ensure that the data of a file is able to be correctly recovered even if several consecutive sectors within the file are damaged, or filesystem 260 provides redundancy protection for metadata therein to prevent the unavailability of metadata from rendering the entirety of filesystem 260 unreadable.

Timestamp manager 235 refers to a component or module that is programmed, designed, or otherwise configured to timestamp each KV pair, automatically or manually, thus enabling convenient implementation of MVCC-related features.

Timestamp manager 235 ensures that upper layer applications, e.g., L0 or L1, have timestamp values that strictly increase over time for a same key, to thereby ensure expected behavior during a reading process. A user timestamp may be combined with a user key and stored as a unified key within sorted engine 200. During encoding, a timestamp may be used to ensure that internal keys in sorted engine 200 are sorted first.

As shown in FIG. 2B, timestamp manager 235 addresses MVCC by enabling timestamps to be assigned to each KV pair. This timestamp functionality seamlessly integrates MVCC-related features. A higher time stamp value indicates a more recent version of the data, and an upper layer application is ensure that time stamp values strictly increase over time for the same key, ensuring expected behavior during the reading process. A timestamp is to be combined with a user key and stored as a unified Key within engine 200. During encoding, internal keys in engine 200 are to be sorted first based on the timestamp, and then based on the internal segment number.

The timestamp does not replace the internal segment number in engine 200, even if an upper layer application ensures strict incremental ordering for timestamps of the same key since a timestamp from the upper layer application typically follows a strict increment within a key or a certain range of keys, e.g., database LSN (Log Sequence Number) provides incremental writes within a segment, while the LSNs corresponding to data between segments do not necessarily provide sequential ordering. If the timestamp is directly used as the internal segment number, an internal snapshot mechanism is to maintain independent snapshot numbers for each incremental unit, e.g., segment, resulting in excessive coupling between layers and complex snapshot mechanisms. The internal segment number is globally incremental, which can be used to traverse internal snapshots, meaning that a single value may represent a Snapshot, as illustrated in FIG. 2B.

A KV store, i.e., KV layer, is to enable read, write, and delete functions to support time stamp, allowing users to associate timestamps with KV operations; implement garbage data collection (deletion) through compaction processes to remove expired time stamp data and ensure data integrity; and trigger proactive compaction when capacity limits are reached, identifying the SST/Blob with the highest number of garbage versions. This initiates a compaction process to efficiently reclaim storage space. By incorporating these features, robustness and efficiency are enhanced, providing comprehensive support for time stamp management, ensures data integrity, and optimizes storage utilization.

These features enhance the robustness and efficiency of engine 200, providing comprehensive support for time stamp management, data integrity, and efficient storage utilization.

Multi-tenant manager 240 refers to a component or module that is programmed, designed, or otherwise configured to provide shard-level resource limitations and isolation since upper layer applications, e.g., L0 or L1, may have different resource usage limits for different shards. Non-limiting examples of such resources include I/O bandwidth, memory size, and the number of threads, e.g., a number of async I/O execution threads/compaction threads, since upper-level applications are configured to have resource usage caps for various engines and shards. Additionally, multi-tenant manager 240 is programmed, designed, or otherwise configured to provide periodic monitoring and resulting statistics regarding usage of each resource type, allowing an upper layer to dynamically adjust quota values for each resource type on different shards based on their resource monitoring status, thus facilitating multi-tenancy functionality.

Multi-tenant manager 240 is programmed, designed, or otherwise configured to monitor real-time resource usage status for each shard so that, e.g., an upper layer application may dynamically adjust quota values for each shard accordingly, to thereby maximize resource utilization.

Compaction/GC manager 250 refers to a component or module that is programmed, designed, or otherwise configured to coordinate the background mechanisms of GC/Compaction in storage, e.g., SSD 265, with GC in filesystem 260, thus proactively reducing end-to-end WAF.

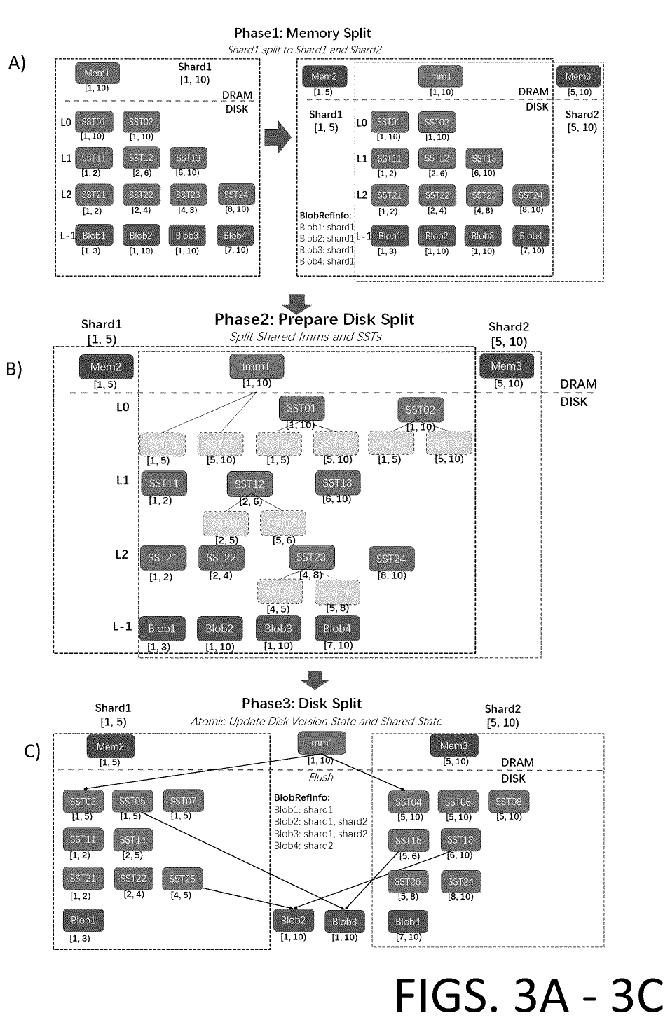

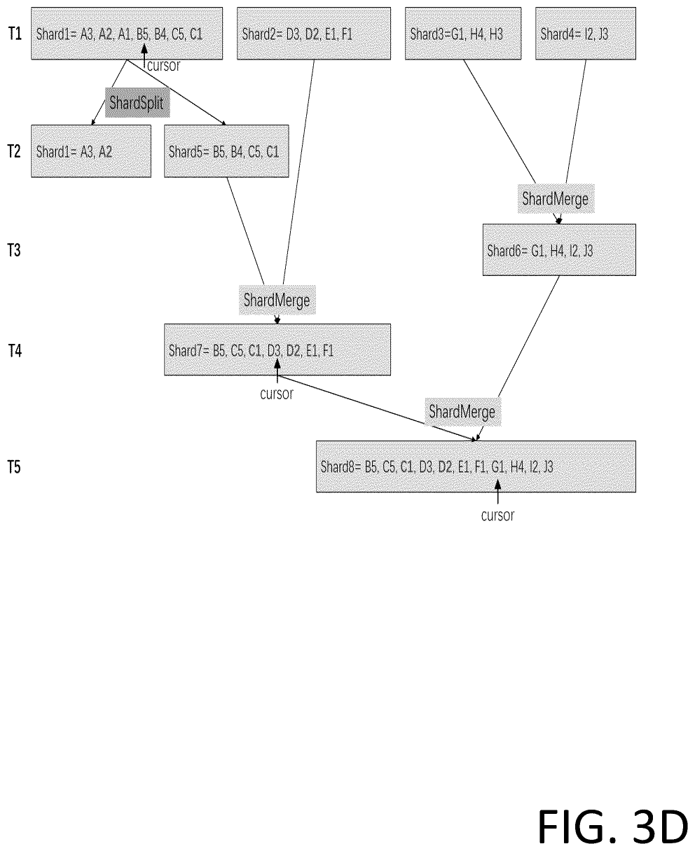

FIGS. 3A-3C show stages of a non-limiting example of data splitting, as executed and managed by sharding manager 205. Data splitting, as generally depicted in FIGS. 3A-3C is designed to be completed quickly so as to minimize any impact on frontend I/O. Further, splitting data into left and right halves is implemented to render distribution and management in a distributed database system more efficient by, e.g., reducing LSM tree height.

FIG. 3A shows phase 1 of data splitting, in accordance with a non-limiting example embodiment. It is assumed that shard 1 is regarded as a parent shard and shard 2 is regarded as a child shard. Further, Parent shard 1's range before splitting is [X, Y), and upon splitting at a split point, the updated range for Parent shard 1 is [X, SplitPoint). Thus, the range for child shard 2 is [SplitPoint, Y). shard 1 has layers L0, L1, L2, L−1 of data.

In phase 1, depicted in the blocks of FIG. 3A, frontend write I/O is blocked, while read I/O is unaffected; background tasks including compaction, flush, and GC are temporarily paused; a file deletion switch is temporarily disabled; a currently writing memory table is made immutable, i.e., with immutable content; child shard 2 is created, with a memory version of parent shard 1, which includes the immutable memory table, being cloned and assigned to shard 2. Thus, shard 1 and shard 2 fully share the immutable data until the split process concludes. A new memory table is then created for child shard 2 and is added to a memory version corresponding to shard 2, and key range metadata of shard 1 and shard 2 is updated. Front end write I/O blocking is then lifted, and background task execution switches are reactivated.

In phase 2, depicted in the blocks of FIG. 3B, the memory table and SST that include the split point are split to create temporary SST files by setting the split point, and then subsequent flush and compaction tasks in the respective shards generate SST files that do not simultaneously include data before and after the split point; existing SSTs that simultaneously contain data before and after the split point are rewritten to avoid overlap. Data falling within the original shard 1 key range, but before the split point, continue writing to shard 1, while data falling after the split point is written to shard 2.

In phase 3, depicted in the blocks of FIG. 3C, version data of post-split shard 1 and shard 2 is written to storage, while maintaining atomicity. This is done by temporarily pausing background tasks, e.g., compaction, flush, GC, etc.; removing files that do not intersect with the respective ranges from the memory version. flush the version data of shard 1 and shard 2 from memory to disk atomically. Upon completion, the paused background tasks, e.g., compaction, flush, GC, etc.; are reopened for execution.

It is noted that, if phase 1 split fails before phase 2, the data on disk remains unaffected. The in-memory split process is rolled back by, e.g., removing the temporarily created shard 2 and reverting to the phase 1 split point.

If phase 1 succeeds, but an I/O exception during phase 3 leads to a split failure, two options for proceeding include performing a proper rollback of phase 1 to 3 and return to the previous state. Phase 1 and 2 need to roll back in-memory states, while phase 3 requires a rollback of disk states. Subsequent write requests are blocked and upper layer L0 is instructed to restart the database. In this case, restarting the database clears any data that was not successfully processed during the last moment.

After the split, some blob files that store values in a Key-Value (KV) format may be shared among multiple shards. Therefore, careful handling is required during Garbage Collection (GC) and deletion of blob files. To ensure efficient management, information is maintained in storage 265 regarding shard references for each blob file involving adding references and removing references.

During the split process, references are added to shared blob files, and blob files are migrated from parent shard 1 to child shard 2.

As referenced herein, a “blob file” is a term of art and may refer to object storage solutions for cloud services that may be binary files for storing the data outside of the LSM-tree, e.g., storing the value(s) in the separated key-value system. SST entries may include keys or pointers to one or more blob files, e.g., the blob files may be shared between one or more SST entries.

FIG. 3A pertains to memory split, which is designed to quickly complete the process and minimize the impact on frontend I/O. Memory split includes the following, assuming shard 1 [1, 10) is split at point 5 into shard 1 and shard 2): frontend write I/O is blocked, while read I/O is unaffected. Background tasks such as compaction, flush, and GC are temporarily paused. The file deletion switch is temporarily disabled. SwitchMemtable: The currently writing Memtable is converted into an Immutable Memtable with immutable content (e.g., Mem1 switches to Imm1 in the illustration). A new shard 2 is created, and the memory Version of shard 1, which includes the Immutable parts (Immutable Memtable and SST), is cloned and assigned to shard 2. This means shard 1 and shard 2 fully share the Immutable data until the split process concludes. A new Memtable is created for shard 2 and added to its memory Version (e.g., Mem3 is the newly created Memtable for shard 2). The KeyRange metadata of shard 1 and shard 2 is updated. After phase 2, data falling within the original shard 1 KeyRange, but before the SplitPoint, should continue writing to shard 1, while data falling after the SplitPoint should be written to shard 2 (e.g., shard 1 KeyRange is updated to [1, 5), and shard 2 KeyRange is updated to [5, 10) as shown). Frontend write I/O blocking is lifted. Background task execution switches are reactivated.

FIG. 3B pertains to preparation of a disk split, which is to shorten phase 3 processing time since phase 3 blocks flush and compaction. To limit the WriteBuffer's total size, writes may only be unblocked for a short period. In the Prepare Disk split stage, the current SST and Imm containing the SplitPoint are split at the SplitPoint to create new temporary SST files. The steps include:

Setting the SplitPoint: After setting the SplitPoint, all subsequent flush and compaction tasks in this shard will generate SST files that do not simultaneously include data before and after the SplitPoint. Rewriting all existing SSTs that simultaneously contain data before and after the SplitPoint to ensure they no longer overlap to allow for smooth separation of all SST files in phase 3, although these newly generated SST files will not be visible to shard 1 and shard 2 for the time being (e.g., SST01 is rewritten to <SST05, SST06>, and SST02 is rewritten to <SST07, SST08> in the illustration).

It is noted that no split rewrite operation is performed on BlobFiles during this step because almost all BlobFiles are unordered, and designing a rewrite would result in most BlobFiles needing to be rewritten during the split process causing significant write amplification overhead and lengthen the split execution time. Instead, BlobFiles are managed through shared file management.

FIG. 3C pertains to disk split, which is to write version data of the post-split shard 1 and shard 2 to disk, and this writing process must maintain atomicity. The specific steps include temporarily pausing background tasks (Compaction, flush, GC); removing SST and BlobFiles in shard 1 and shard 2 that do not intersect with their respective ranges from the Memory Version. Since most SSTs are arranged in order (L1˜LN), the overlapping SSTs in phases 1 and 3 have already been rewritten ensuring a complete separation. However, in the case of BlobFiles, there may still be two shards sharing the same BlobFile after the split. Version data of shard 1 and shard 2 are flushed from memory to disk atomically. Upon successful completion, background tasks, e.g., compaction, flush, GC) are reopened.

With regard to shard split consistency, if phase 1 Memory split fails before phase 2, data on disk remains unaffected. The in-memory split process may be rolled back, including removing the temporarily created shard 2 and reverting the phase 1 SplitPoint setup.

If phase 1 succeeds, but an I/O exception during phase 3 leads to a split failure, options include performing a proper rollback of phase 1 to 3 and return to the previous state. Phase 1 and 2 need to rollback some in-memory states, while phase 3 requires a rollback of some disk states.

Similar to RocksDB, set BGError to block subsequent write requests and inform the upper layer to restart the DB. In this case, restarting the DB clears data that was not successfully processed during the last moment (considering the low probability of local disk I/O errors, this approach is simpler and more reliable).

FIG. 3D is an illustration of a consistent cross-shard range scan, in accordance with the non-limiting example embodiments of data splitting described and recited herein.

As set forth above, with reference to FIG. 1, collaboration layer 112 is configured to facilitate collaboration between key-value engine 102 and filesystem 114. In accordance with the non-limiting example embodiments of FIGS. 3A-3C, due to the adoption of a multi-shard strategy, applications at an upper layer may encounter one or more shards while performing range searches using an iterator. Additionally, a range search operation may trigger multiple seek and next sub-operations. During such process, Shards related to the range search may be affected by split and merge operations. Therefore, range search operations are to traverse results without any duplicates or missing entries, and return them in the correct order to the upper layer application.

As shown in FIG. 3D, for descriptive purposes only, it is assumed that there are four Shards at time T1. At this moment, the KV layer receives a range query request to traverse the range [B, Upon receiving the request, the KV layer obtains a snapshot number. Again, for descriptive purposes only, it is assumed that the returned snapshot number is 2. Snapshots for all shards are managed in the DB uniformly to ensure that, once a snapshot is obtained, all shards in the DB have access to that snapshot. Such consistency allows for range queries spanning multiple shards. After the snapshot(s) is obtained, the range search will start from position B5 in shard 1.

At time T2, Shard 1 splits into shard 1 and shard 5. The split shards may still access the snapshot created by the DB at time T1, and data related to the snapshot is preserved during the compaction process, e.g., A2, C1, D2.

After traversing all the data in shard 1 at time T4, a current cursor position may be utilized to locate a position of the next shard. For example, if the cursor is at C1, the first shard greater than C1 is shard 7. Therefore, the traversal continues within shard 7 starting from a position greater than C1, i.e., cursor=D3. Similarly, after traversing the last element F1 in shard 7 at time T5, traversal continues from position G1 in shard 8. This process repeats until all relevant elements have been traversed.

In range searches, multiple shards could be traverses, which may entail additional seek overhead since the first search on each shard utilizes a seek operation. To mitigate this overhead, collaboration between the KV layer and the upper layer may be considered. For example, during shard splitting, appropriate splitting points may be chosen to avoid cross-shard range scan operations. If the range search in NDB always includes a fixed segment-ID prefix, each shard splitting process ensures that KV data with the same segment-ID prefix is allocated to the same shard, thereby avoiding the performance impact of cross-sard read operations.

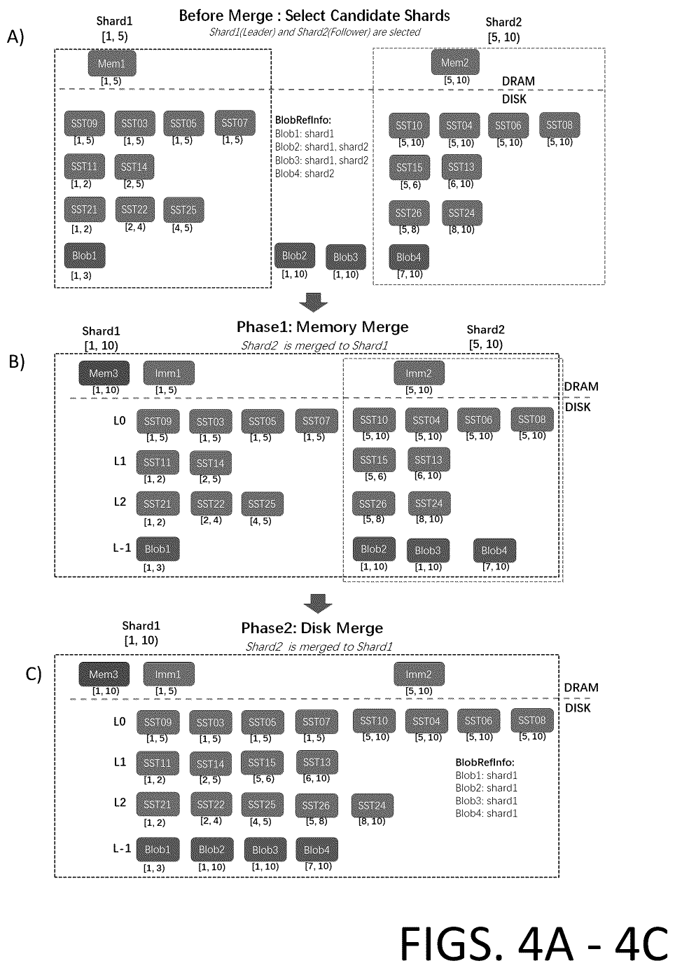

FIGS. 4A-4C show stages of a non-limiting example of data merging, as executed and managed by sharding manager 205. Merging at least shard 1 and shard 2 includes combining two adjacent shards with overlapping ranges into one.

Assuming that leader shard 1 and adjacent follower shard 2 have volume less than a predetermined threshold level and are therefore to be merged, the range of shard 1 is [X, Y) and the range of shard 2 is [Y, Z). The range of the resulting merged shard will be [X, Z).

In phase 1 of data merging, as depicted in the blocks of FIG. 4A, essential metadata is added to leader shard 1 to provide access to data stored in follower shard 2. Thus, all new read and write requests falling within the range [X, Z) are directed to leader shard 1, and follower shard 2 no longer accepts new requests. Reads are not blocked, but writes, flush, and compaction operations are blocked.

In phase 2 of data merging, as depicted in the blocks of FIG. 4B, memory states merged in phase 1 are executed with disk operations, and follower shard 2 is removed from DB. Read and write are not blocked in the short term, but flush and compaction operations, remain blocked.

A merged shard is depicted in FIG. 4C, allowing for efficient consolidation of shards, ensuring data integrity and minimizing disruptions to read and write operations during the merging process.

In data merging, when a shard creates a new blob file, it automatically establishes a reference to that blob file. On the other hand, when a shard intends to delete a blob file, it must first confirm whether the blob file is exclusively referenced by itself. If so, the shard proceed with the immediate deletion and removal of the reference entry. Otherwise, the shard should only remove its own reference to the blob file. Additionally, a recent snapshot of the blob file reference information is written into a new manifest. This periodic checkpoint effectively organizes the historical reference changes of blob files stored in the manifest, thereby ensuring data consistency and minimizing redundancy.

Also, when an upper-level distributed system layer is to migrate an entirety of shard data from one node to another, all relevant files, e.g., SST, blob, etc., of that shard are transferred over a network to the target node and an ingest file operation is performed. However, because blob files may be shared among multiple column families (CF), a same blob file may contain valid data from multiple CFs. To reduce an amount of data transferred over the network, a Garbage Collection (GC) operation could be performed on all shared blob files before migration, thus copying all relevant data of that shard to a new set of exclusive blob files.

Shard migration includes a preparation phase by which shared blob files are selectively cleaned to reduce an amount of data transferred over the network. shard migration also includes an execution phase, in which, upon initiation by a source node, all SST and blob files are exported from a shard in file format. Relevant files are directly copied and exported, and a latest version snapshot of the shard is written into a temporary manifest file. Further, upon initiation by a destination node, based on the data received over the network from the source node, a new empty shard is created at the destination node. To avoid file number conflicts, all SST and blob files that are to be imported are re-assigned new file numbers in the destination database, followed by a rename operation. Parsing the content of the received temporary manifest file generates a version snapshot and applies the new file numbers of all corresponding files to the version snapshot. The new version snapshot is appended to the DB's Manifest.

Shard migration includes transferring relevant data files of the shard to the target node and carefully managing shared blob files to reduce data duplication during the migration process. The migration process ensures data consistency and minimizes network transfer volumes for efficient and successful shard relocation.

Sharding manager 205 implements sharding manually or automatically.

With regard to FIGS. 3A-3C, and even FIGS. 4A-4C described below, an upper-layer storage system calls the splitShard/MergeShard interfaces. In accordance with non-limiting example embodiments of manual sharding, phase 2 and phase 3 of data splitting are executed asynchronously in the background, allowing phase 1 to return immediately after completion.

Auto sharding includes is implemented internally within the KV Engine, which periodically selects target shards for data splitting and data merging operations based on specific rules. Both splitting and merging use the following two basic operations:

Auto shard split: When an upper-layer system cannot predict a distribution range of keys in advance, shard sizes are dynamically monitored during runtime. When a database is opened, a dedicated background thread is used to monitor the size status of shards and issues instructions for data splitting or data merging based on the monitored size/volume conditions.

Auto shard merge: To control the upper limit of the total number of shards within an instance, it is necessary to automatically merge small consecutive shards, limiting the management pressure on shards within a single database. threshold values to initiate an auto shard merge include:
Leader shard 1 size+follower shard 2 size merge size threshold
Leader shard 1 TPS≤TPS threshold & follower shard 2 TPS≤TPS threshold

Applications at an upper layer of a respective shard may encounter one or more shards while performing range searches using an iterator. Additionally, a range search operation triggers multiple seek and next sub-operations. Thus, shards related to the range search are also affected by data split and data merge operations. Therefore, the range search operation should traverse results without any duplicates or missing entries, and return them in a correct order to the upper layer application.

When a snapshot is obtained, all shards in the database have access to that snapshot. This consistency allows for range queries spanning multiple shards.

FIG. 4A shows that shard merge is used to combine two adjacent shards with overlapping ranges into one. The process of shard merge is similar to shard split, but it does not require a prepare phase since there will be no range overlap between shards after the split.

Shard merge consists of (1) assuming the two shards to be merged are adjacent: the left shard range is [X, Y) and the right shard range is [Y, Z). The resulting merged shard range will be [X, Z); and the left range shard before the merge is referred to as the leader, and the right range shard is referred to as the follower.

FIG. 4B pertains to memory merge by which essential metadata is added to the leader shard to allow it to access the data stored in the follower shard. Next, new read and write requests falling within the [X, Z) range are directed to the leader shard, and the follower shard no longer accepts new requests. This process does not block reads but does block writes, flush, and compaction operations.

FIG. 4C pertains to disk merge in which memory states merged in phase 1 are executed with actual disk operations, and the follower shard is removed from the DB (the removal process is managed through reference counting, and the shard is only released when all references to it reach zero). This process does not block reads and writes in the short term, but it does still block flush and compaction operations.

Shard merge allows for efficient consolidation of shards, ensuring data integrity and minimizing disruptions to read and write operations during the merging process.

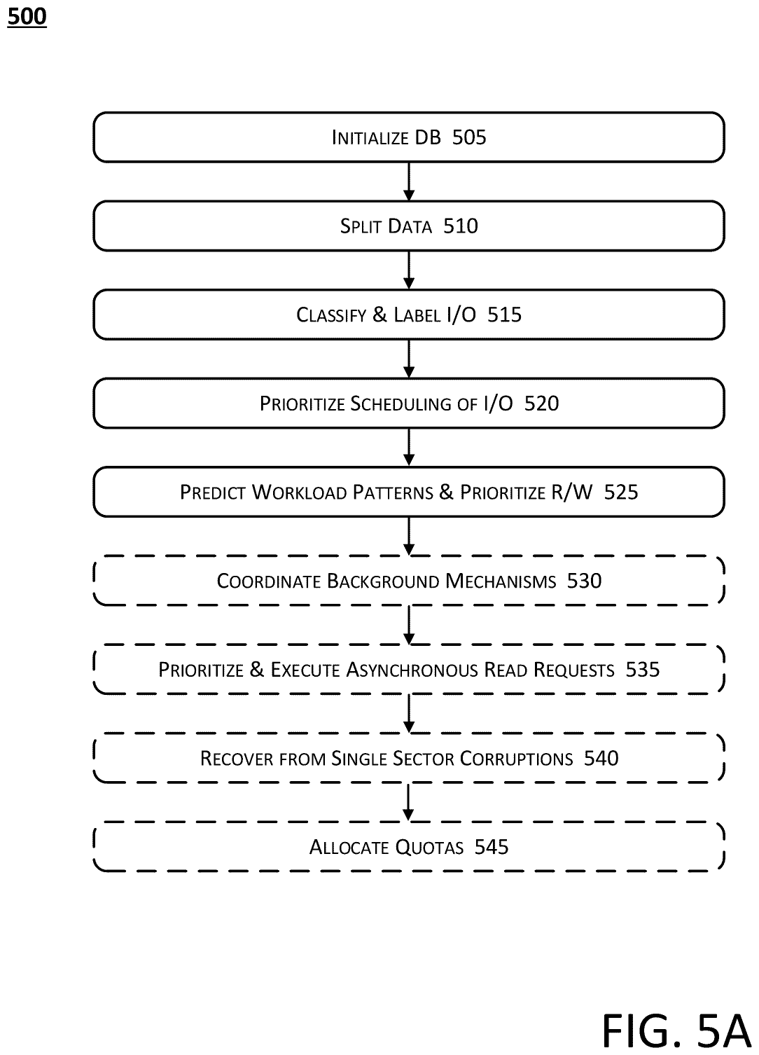

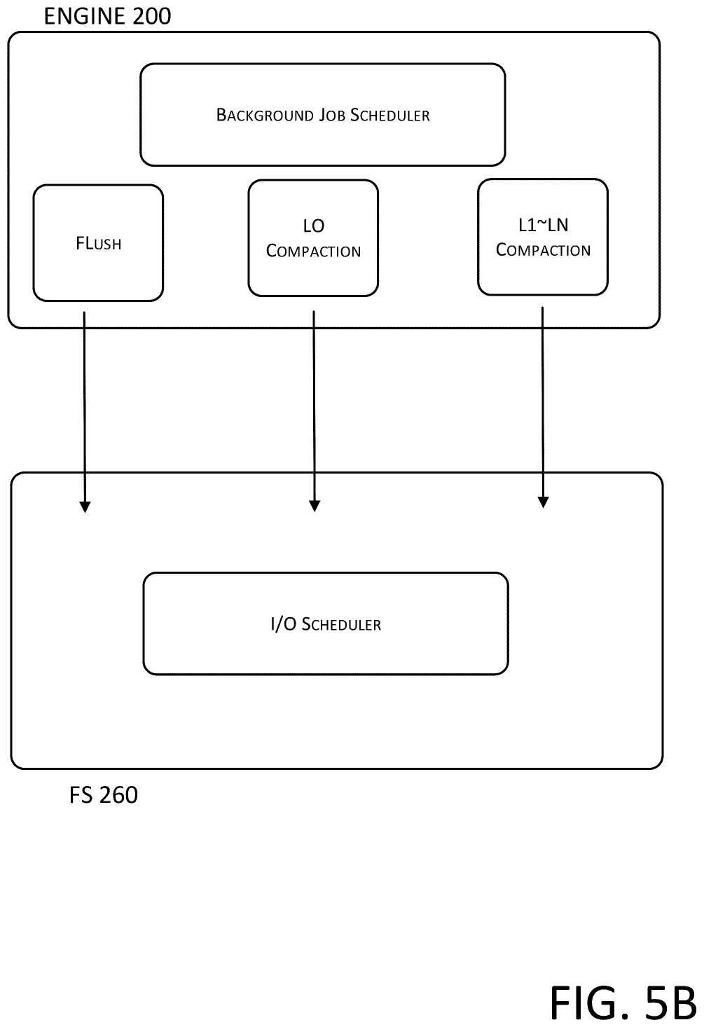

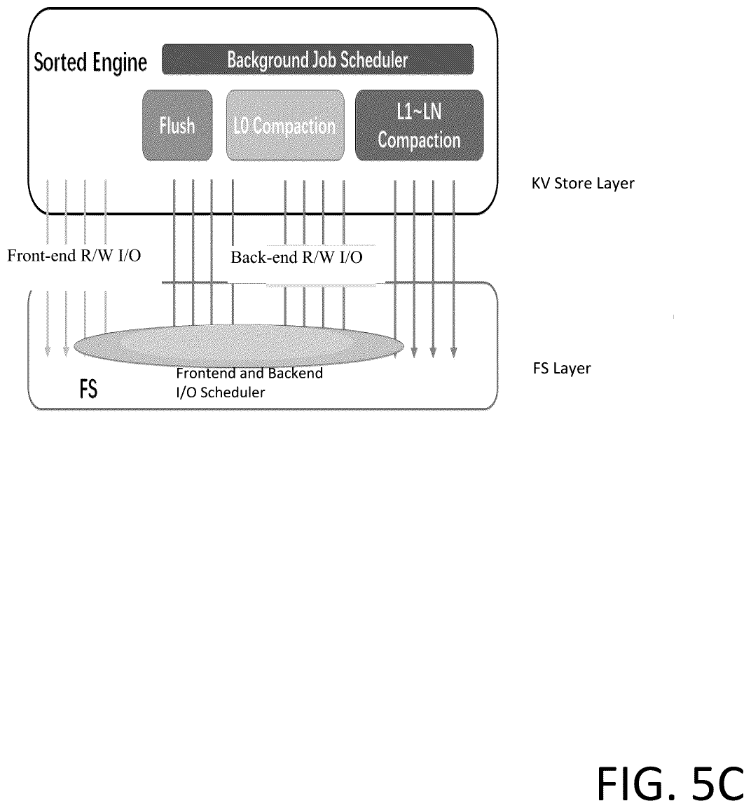

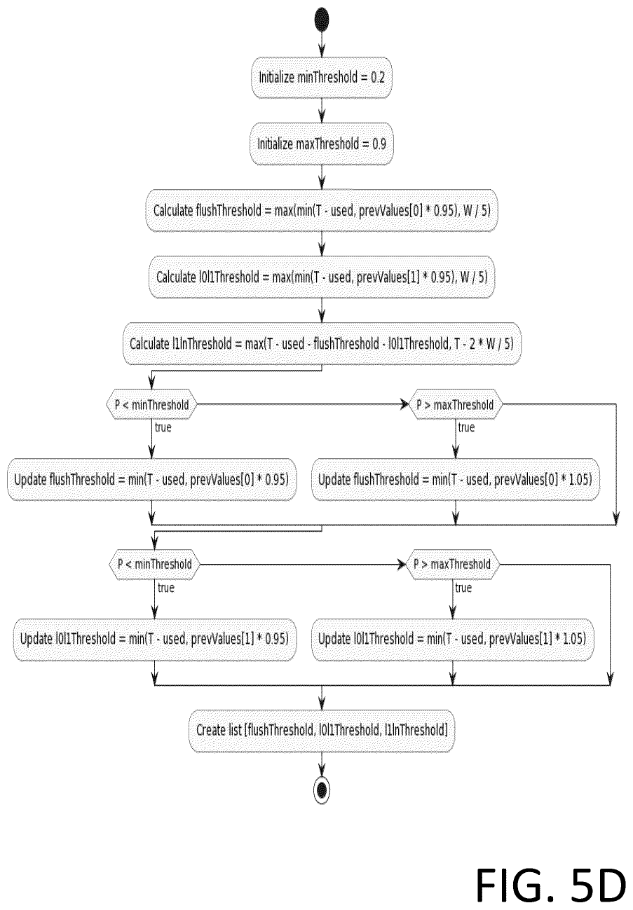

FIG. 5A shows a non-limiting example storage processing flow, in accordance with at least some embodiments described and recited herein.

As depicted, processing flow 500 includes operations, actions, or functions, as illustrated by representative blocks 505, 510, 515, 520, 525, 530, 535, 540, and 545. These various operations, functions, or actions may correspond to, e.g., software, programmed code, or programmed instructions executable by firmware that causes the functions to be performed. Although illustrated as discrete blocks, obvious modifications may be made, e.g., two or more of the blocks may be re-ordered; further, one or more blocks may be added; and various blocks may be divided into additional blocks, combined into fewer blocks, or even eliminated, depending on the desired implementation. Processing flow 500 may begin at block 505.

Block 505 (Initialize DB) refers to initialization of a database (DB) class to provide functionalities for managing and interacting with an underlying storage engine. The initialized DB class includes methods that function to, e.g., initialize the database with specified options, including, but not limited to creating an engine with given options, engine name, and engine type, returning an engine handle, dropping sorted engine 200 along with its associated data, retrieving an engine handle for a specified engine name, etc.

Block 510 (Split Data) refers to sharding manager 205 automatically or manually splitting data from a large LSM tree structure into smaller LSM tree structures, i.e., shards, to thereby reduce a total number of layers in the LSM tree and minimizing write amplification. Alternatively, when the data within a data structure decreases due to deletions, and the volume thereof falls below a specific threshold, block 510 could refer to the data structure being manually or automatically merged with one or more adjacent shards to form a single shard.

Block 515 (Classify & Label I/O) refers to I/O classifier 215 classifying and labeling each I/O based on its type, to facilitate a lower-level filesystem to prioritize scheduling between different types of I/O to- and from-storage, thus ensuring stable latency for individual I/O operations, thus ensuring timely thread scheduling for high-priority tasks.

In accordance with the non-limiting example embodiments described and recited herein, I/O sent to FS 260 may be tagged to differentiate foreground and background tasks. On the filesystem side, I/O scheduler 220 may prioritize I/O based on such tag to minimize the foreground latency. To ensure that high-priority tasks receive timely thread scheduling, three background thread pools may be maintained to schedule different types of background tasks including (1) Flush uses the High-Priority thread pool, (2) L0->L1 compaction uses the Medium-Priority thread pool, and (3) L1-LN compaction uses the Low-Priority thread pool.

With reference to the example of FIG. 5D, when L0->L1 Compaction is executed, L1->L2 Compaction may be directly pre-empted. When L0->L1 Compaction is needed, currently executing L1->L2 Compaction is to be immediately stopped. The I/O bandwidth of high-priority tasks may face being preempted by low-priority tasks, leading to untimely processing and impacting foreground latency stability. Thus, assuming the upper limit for foreground writes is W bytes/sec, to prevent blocking I/O execution thereof, bandwidth limits for flush and L0->L1 compaction are set as W bytes/sec each. Using three independent rate limiters for each type of thread task may result in L1->LN compaction consistently executing within a very low bandwidth limit, even when no flush or L0->L1 compaction is being executed. Therefore, bandwidth thresholds for the three tasks are dynamically adjusted based on their priorities within the same rate limiter. To gradually increase or decrease bandwidth upper limits for different tasks based on their priority, the following may be implemented.

Assuming the total rate limiter threshold is T bytes/sec, the bandwidth thresholds for flush and L0->L1 compaction may be dynamically controlled within the range of [W/5, W]. Initially, I/O bandwidth thresholds for flush tasks and L0->L1 compaction may be set to their lower limit of W/5 bytes/sec, and the threshold for L1->LN compaction may be set to the remaining bandwidth (T-2W/5) bytes/sec. Every fixed interval, e.g., 100 ms, new I/O bandwidth thresholds for flush, L0->L1 compaction, and L1->LN compaction are sequentially adjusted. When bandwidth thresholds for the current two types of tasks are determined, the allocated bandwidth threshold for the lowest priority task may be obtained by subtracting the sum of the previous two tasks' thresholds from the total threshold. The specific adjustment for each task's bandwidth threshold considers (1) that the adjustment is primarily based on the statistical proportion of triggering the rate limiter upper limit within the previous cycle for that task, assuming the proportion is P; (2) when P is less than the minimum threshold, e.g., 20%, the I/O bandwidth threshold for that task may be set to Min(T-used, prevValue*95%); (3) when P is greater than the maximum threshold, e.g., 90%, the I/O bandwidth threshold for that task may be set to Min(T-used, prevValue*105%); and (4) otherwise, the I/O bandwidth threshold for that task remains unchanged (maintain prevValue) in the next cycle.

The subsequent RateLimiter of Sorted Engine restricts the background task traffic of the sorted engine layer and also collaborates with the filesystem to provide a unified frontend.

Block 520 (Prioritize Scheduling of I/O) refers to job scheduler 220 cooperating with FS layer 260 to ensure stable latency for individual I/O operations to- and from-storage, e.g., SSD 265. Job scheduler 220 provides stable read amplification in the KV layer and prevents adverse conditions, e.g., WriteStall and WriteStop, to enhance or even optimize data retrieval and reduce tail latency. See FIG. 5B for an example implementation thereof.

A primary cause of write stall and/or write stop may a write buffer becoming full, which is primarily due to slow flush processes. Higher-level concurrent compaction may seize I/O bandwidth of flush, resulting in slower flush speed compared to write buffer write speed.

I/O Amplification in may be determined by the total number of levels in the LSM within each shard and the number of L0 files. The size of each shard through dynamic partitioning may be controlled to maintain the total number of LSM levels within a fixed range. Consequently, the read I/O amplification is primarily influenced by the number of L0 files. An increase in the number of L0 files may occur due to slow L0->L1 compaction, which can be caused by (1) the single thread pool for current compaction, which can result in queuing delays for L0->L1 compaction when higher-level compactions are ongoing, or (2) concurrent higher-level compactions seizing the I/O bandwidth of L0->L1 compaction.

As shown generally in FIG. 5B and with greater detail in FIG. 5C, to ensure stability in latency, different background tasks may be differentiated based on their priority and different I/O bandwidth resources may be allocated accordingly. Background tasks may be categorized.

Fast flush may be prioritized, meaning flush has the highest priority, thus clearing enough space in the memory's write buffer to accommodate foreground write requests in a timely manner. The speed of flush directly affects the latency of write tail. Also, L0->L1 Compaction task may be set as the second priority. If L0->L1 compaction is slow, it directly increases a number of read I/O operations, thereby extending the read latency tail. Apart from flush and L0->L1 compaction, L1˜LN compaction has the lowest priority. These compaction tasks may be used to maintain the form of LSM and do not have a significant impact on read and write latency in the short term.

Not all background tasks require equal sharing of system resources. Tasks such as flush and L0->L1 compaction have higher priority. If these operations are not completed in a timely manner, it leads to increased write stall events and amplified read I/O operations.

Block 525 (Predict Workload Patterns & Prioritize R/W) refers to job scheduler 220 further predicting workload patterns and adjusting the scheduling of read and write operations accordingly, to thereby maintain stable read amplification and preventing performance degradation.

Block 530 (Coordinate Background Mechanisms) refers to I/O classifier 215 optionally ensuring timely thread scheduling for high-priority tasks and maintaining multiple distinct background thread pools to executie different types of background tasks that include, but are not limited to, in order of descending priority, flush operations, L0->L1 compaction tasks, and L1->LN compaction tasks. L0->L1 compaction directly preempt L1->LN compaction, to thereby reduce end-to-end WAF.

Block 535 (Prioritize & Execute Asynchronous Read Requests) refers to asynch API manager 225 optionally supporting asynchronous reads to thereby allow I/O waiting without blocking upper layer threads from executing other tasks.

Block 540 (Recover Single Sector Corruptions) refers to fault tolerance manager 230 optionally providing sector-level fault tolerance capabilities so that single sector corruption within a file does not affect data consistency and visibility. For example, fault tolerance manager 230 generates data redundancy blocks for critical file data to ensure that the data of a file is able to be correctly recovered even if several consecutive sectors within the file are damaged. Alternatively, filesystem 260 provides redundancy protection for metadata therein to prevent the unavailability of metadata from rendering the entirety of filesystem 260 unreadable.

Block 545 (Allocate Quotas) refers to multi-tenant manager 240 optionally providing shard-level resource limitations and isolation since upper layer applications, e.g., L0 or L1, may have different resource usage limits for different shards by, e.g., providing periodic monitoring and resulting statistics regarding usage of each resource type, allowing an upper layer to dynamically adjust quota values for each resource type on different shards based on their resource monitoring status, thus facilitating multi-tenancy functionality.

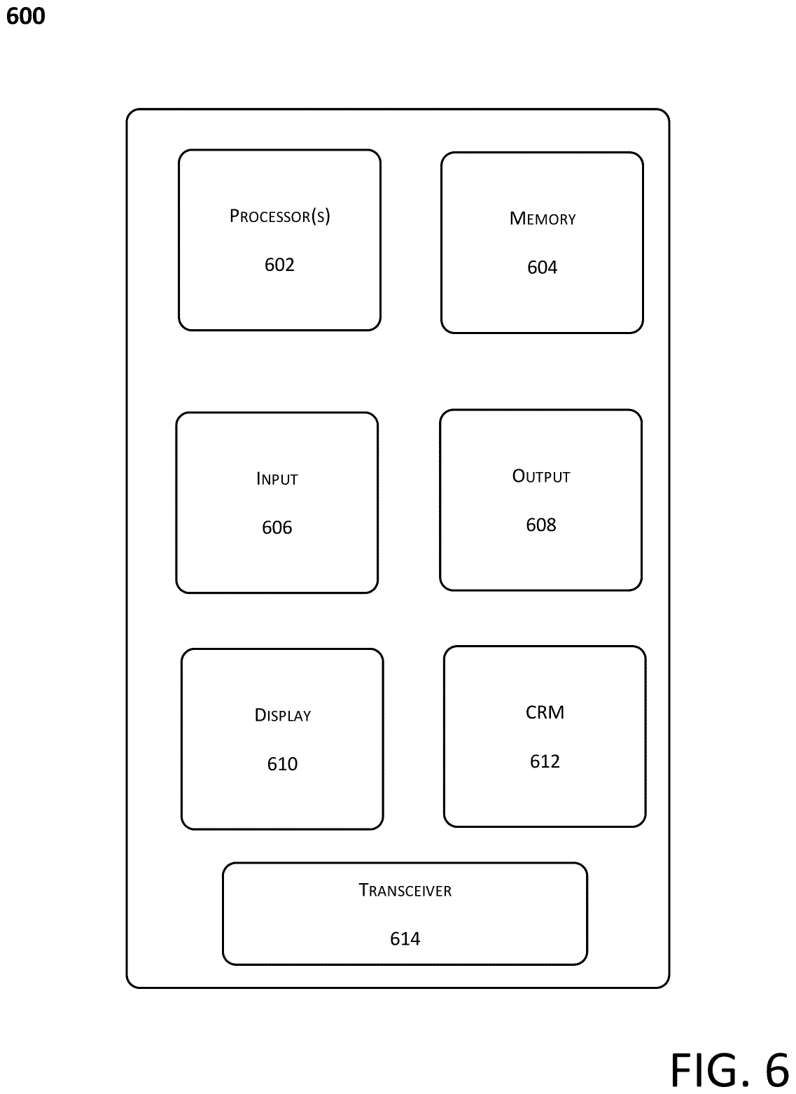

FIG. 6 shows an illustrative computing embodiment, in which any of the processes and sub-processes of training a unified transformer-based visual place recognition (VPR) training framework may be implemented as executable instructions stored on a non-volatile computer-readable medium. The computer-readable instructions may, for example, be executed by a processor of a device, as referenced herein, having a network element and/or any other device corresponding thereto, particularly as applicable to the applications and/or programs described above corresponding to sorted engine 200.

In a very basic configuration, a computing device 500 may typically include, at least, one or more processors 602, a memory 604, one or more input components or modules 606, one or more output components or modules 608, a display component or module 610, a computer-readable medium 612, and a transceiver 614.

Processor 602 refers to, e.g., a microprocessor, a microcontroller, a digital signal processor, or any combination thereof.

Memory 604 refers to, e.g., a volatile memory, non-volatile memory, or any combination thereof. Memory 604 stores therein an operating system, one or more applications corresponding to model 205 and/or program data therefore. That is, memory 604 stores executable instructions to implement any of the functions or operations described above and, therefore, memory 604 may be regarded as a computer-readable medium.

Input component or module 606 refers to a built-in or communicatively coupled keyboard, touch screen, or telecommunication device. Alternatively, input component or module 606 includes a microphone that is configured, in cooperation with a voice-recognition program that may be stored in memory 604, to receive voice commands from a user of computing device 600. Further, input component or module 606, if not built-in to computing device 600, may be communicatively coupled thereto via short-range communication protocols including, but not limitation, radio frequency or Bluetooth®.

Output component or module 608 refers to a component or module, built-in or removable from computing device 600 that is configured to output commands and data to an external device.

Display component or module 610 refers to, e.g., a solid state display that may have touch input capabilities. That is, display component or module 610 may include capabilities that may be shared with or replace those of input component or module 606.

Computer-readable medium 612 refers to a separable machine-readable medium that is configured to store one or more programs that embody any of the functions or operations described above. That is, computer-readable medium 612, which may be received into or otherwise connected to a drive component or module of computing device 600, may store executable instructions to implement any of the functions or operations described above. These instructions may be complimentary or otherwise independent of those stored by memory 604.

Transceiver 614 refers to a network communication link for computing device 600, configured as a wired network or direct-wired connection. Alternatively, transceiver 614 is configured as a wireless connection, e.g., radio frequency (RF), infrared, Bluetooth®, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

### ASPECTS

Aspect 1. A method to optimize non-volatile storage by performing operations comprising:
splitting data in a first log-structured merge (LSM) tree structure into partitioned shards to reduce a number of layers for the data represented in the first LSM tree structure,
wherein each partitioned shard represents an independent LSM tree structure, thus providing scalability and flexibility for the data represented in the first LSM tree structure,
splitting a respective one of the partitioned shards into at least a parent shard and a child shard when a volume of data therein reaches a threshold level; and
merging a respective one of the partitioned shards into an adjacent one of the partitioned shards when a volume of data of the respective one of the partitioned shards decreases to a volume less than the threshold level.

Aspect 2. The method of Aspect 1, wherein the method further comprises directing new read and write requests to the child shard.

Aspect 3. The method of either Aspect 1 or Aspect 2, wherein the splitting comprises splitting existing sorted string tables (SSTs) between the parent shard and the child shard.

Aspect 4. The method of any of Aspects 1-3, wherein
the shard having the volume less than the threshold level is a follower shard and the adjacent shard into which the follower shard is merged is a leader shard,
essential metadata from the follower shard is added to the leader shard to provide access to data stored in the follower shard, and
new read and write requests are directed to the leader shard.

Aspect 5. The method of any of Aspects 1-4, further comprising:
Classifying I/O to- and from-each of the shards based on type.

Aspect 6. The method of any of Aspects 1-5, wherein the classifying includes:
marking respective I/O with a tag to differentiate foreground tasks from background tasks, and
prioritizing scheduling of respective I/O for each of the shards based on the respective tags.

Aspect 7. The method of any of Aspects 1-6, further comprising:
maintaining predictable ranges of latency of read and write operations by:
   predicting workload patterns for each of the respective shards based on access patterns, and
   prioritizing scheduling of read/write operations for each of the partitioned tree structures based on the predicted workload patterns.

Aspect 8. The method of any of Aspects 1-7, wherein the latency includes write stall, write stop, and I/O amplification.

Aspect 9. The method of any of Aspects 1-8, further comprising:
managing execution of thread pools, thread priorities, and task scheduling concurrently on a filesystem level.

Aspect 10. The method of any of Aspects 1-9, wherein the managing includes alleviating blocking I/O operations to facilitate parallelism, reduce latency, and increase response time.

Aspect 11. The method of any of Aspects 1-10, wherein the job scheduler is to predict workload patterns and prioritize scheduling of read/write operations for each of the partitioned tree structures based on access patterns.

Aspect 12. The method of any of Aspects 1-11, further comprising
establishing resource usage limits for different shards; and
monitoring real-time resource usage for each shard,
wherein the monitoring is utilized to improve resource utilization.

Aspect 13. The method of any of Aspects 1-12, further comprising:
generating data redundancy blocks for critical file data by protecting metadata on a filesystem level to provide redundancy protection.

Aspect 14. The method of any of Aspects 1-13, further comprising:
outsourcing compaction beyond a filesystem, and
allocating storage space by aligning sizes of upper-level files.

Aspect 15. A non-volatile storage having stored thereon executable components, comprising:
a sharding manager configured to:
   split data in a first log-structured merge (LSM) tree structure into partitioned shards to reduce a number of layers for the data represented in the first LSM tree structure,
      wherein each partitioned shard represents an independent LSM tree structure, thus providing scalability and flexibility for the data represented in the first LSM tree structure,
   split a respective one of the partitioned shards into at least a parent shard and a child shard when a volume of data therein reaches a threshold level; and
   merge a respective one of the partitioned shards into an adjacent one of the partitioned shards when a volume of data of the respective one of the partitioned shards decreases to a volume less than the threshold level.

Aspect 16. The non-volatile storage of Aspect 15, further comprising:
an input/output (I/O) classifier to classify and label I/O to and from each of the partitioned shards based on type to facilitate prioritized scheduling between different types of I/O.

Aspect 17. The non-volatile storage of either Aspect 15 or Aspect 16, further comprising:
a job scheduler to predict workload patterns and prioritize scheduling of read/write operations for each of the partitioned shards to provide stable read amplification.

Aspect 18. The non-volatile storage of any of Aspects 15-17, further comprising:
an asynch API manager to prioritize and execute asynchronous read requests for each of the partitioned shards.

Aspect 19. The non-volatile storage of any of Aspects 15-18, further comprising:
a fault tolerance manager to recover from single sector corruptions by utilizing error-correction codes and redundant storage for each of the partitioned shards.

Aspect 20. The non-volatile storage of any of Aspects 15-20, further comprising:
a multi-tenant manager to allocate resource quotas among each of the partitioned shards based on workload demands and monitoring of resources.

1. A method to optimize non-volatile storage by performing operations comprising:
splitting data in a first log-structured merge (LSM) tree structure into partitioned shards to reduce a number of layers for the data represented in the first LSM tree structure,
wherein each partitioned shard represents an independent LSM tree structure, thus providing scalability and flexibility for the data represented in the first LSM tree structure,
splitting a respective one of the partitioned shards into at least a parent shard and a child shard when a volume of data therein reaches a threshold level; and
merging a respective one of the partitioned shards into an adjacent one of the partitioned shards when a volume of data of the respective one of the partitioned shards decreases to a volume less than the threshold level.

2. The method of claim 1, wherein the method further comprises directing new read and write requests to the child shard.

3. The method of claim 1, wherein the splitting comprises splitting existing sorted string tables (SSTs) between the parent shard and the child shard.

4. The method of claim 1, wherein
the shard having the volume less than the threshold level is a follower shard and the adjacent shard into which the follower shard is merged is a leader shard,
essential metadata from the follower shard is added to the leader shard to provide access to data stored in the follower shard, and
new read and write requests are directed to the leader shard.

5. The method of claim 1, further comprising:
classifying I/O to- and from-each of the shards based on type.

6. The method of claim 1, wherein the classifying includes:
marking respective I/O with a tag to differentiate foreground tasks from background tasks, and
prioritizing scheduling of respective I/O for each of the shards based on the respective tags.

7. The method of claim 1, further comprising:
maintaining predictable ranges of latency of read and write operations by:
predicting workload patterns for each of the respective shards based on access patterns, and
prioritizing scheduling of read/write operations for each of the partitioned tree structures based on the predicted workload patterns.

8. The method of claim 7, wherein the latency includes write stall, write stop, and I/O amplification.

9. The method of claim 1, further comprising:
managing execution of thread pools, thread priorities, and task scheduling concurrently on a filesystem level.

10. The method of claim 1, wherein the managing includes alleviating blocking I/O operations to facilitate parallelism, reduce latency, and increase response time.

11. The method of claim 1, further comprising:
establishing resource usage limits for different shards; and
monitoring real-time resource usage for each shard,
wherein the monitoring is utilized to improve resource utilization.

12. The method of claim 1, wherein I/O scheduling includes implementation of multiversion concurrency control based on timestamps for each task.

13. The method of claim 1, further comprising:
generating data redundancy blocks for critical file data by protecting metadata on a filesystem level to provide redundancy protection.

14. The method of claim 1, further comprising:
outsourcing compaction beyond a filesystem, and
allocating storage space by aligning sizes of upper-level files.

15. A non-volatile storage having stored thereon executable components, comprising:
a sharding manager configured to:
split data in a first log-structured merge (LSM) tree structure into partitioned shards to reduce a number of layers for the data represented in the first LSM tree structure,
wherein each partitioned shard represents an independent LSM tree structure, thus providing scalability and flexibility for the data represented in the first LSM tree structure,
split a respective one of the partitioned shards into at least a parent shard and a child shard when a volume of data therein reaches a threshold level; and
merge a respective one of the partitioned shards into an adjacent one of the partitioned shards when a volume of data of the respective one of the partitioned shards decreases to a volume less than the threshold level.

16. The non-volatile storage of claim 15, further comprising:
an input/output (I/O) classifier to classify and label I/O to and from each of the partitioned shards based on type to facilitate prioritized scheduling between different types of I/O.

17. The non-volatile storage of claim 15, further comprising:
a job scheduler to predict workload patterns and prioritize scheduling of read/write operations for each of the partitioned shards to provide stable read amplification.

18. The non-volatile storage of claim 15, further comprising:
an asynch API manager to prioritize and execute asynchronous read requests for each of the partitioned shards.

19. The non-volatile storage of claim 15, further comprising:
a fault tolerance manager to recover from single sector corruptions by utilizing error-correction codes and redundant storage for each of the partitioned shards.

20. The non-volatile storage of claim 15, further comprising:
a multi-tenant manager to allocate resource quotas among each of the partitioned shards based on workload demands and monitoring of resources.
